(19) United States
(12) Patent Application Publication
(10) Pub. No.: US 2011/0198937 A1
(43) Pub. Date: Aug. 18, 2011

(54) IMPEDANCE NEUTRAL WIRELESS POWER RECEIVERS

(75) Inventor: Ryan Tseng, Coronado, CA (US)

(73) Assignee: QUALCOMM INCORPORATED, San Diego, CA (US)

(21) Appl. No.: 13/020,778

(22) Filed: Feb. 3, 2011

Related U.S. Application Data
(60) Provisional application No. 61/304,655, filed on Feb. 15, 2010.

(51) Int. Cl. H02J 17/00

(52) U.S. Cl. 307/104

(57) ABSTRACT

Exemplary embodiments are directed to wireless power receivers. A receiver may include receive circuitry configured to couple to a receiver coil and a load. The receiver is configured to be tuned according to the load to enable an impedance as seen by an associated transmitter to remain substantially constant upon positioning the receiver within a charging region of the transmitter.

### CLAIM OF PRIORITY UNDER 35 U.S.C. §119

This application claims priority under 35 U.S.C. §119(e) to:

U.S. Provisional Patent Application 61/304,655 entitled “NOVEL, METHOD AND APPARATUS FOR IMPEDANCE NEUTRAL RECEIVERS” filed on Feb. 15 2010, the disclosure of which is hereby incorporated by reference in its entirety

### BACKGROUND

1. Field

The present invention relates generally to wireless power, and more specifically, to systems, device, and methods related to impedance neutral receivers within a wireless power system.

2. Background

Approaches are being developed that use over the air power transmission between a transmitter and the device to be charged. These generally fall into two categories. One is based on the coupling of plane wave radiation (also called far-field radiation) between a transmit antenna and receive antenna on the device to be charged which collects the radiated power and rectifies it for charging the battery. Antennas are generally of resonant length in order to improve the coupling efficiency. This approach suffers from the fact that the power coupling falls off quickly with distance between the antennas. So charging over reasonable distances (e.g., >1-2 m) becomes difficult. Additionally, since the system radiates plane waves, unintentional radiation can interfere with other systems if not properly controlled through filtering.

Other approaches are based on inductive coupling between a transmit antenna embedded, for example, in a “charging” mat or surface and a receive antenna plus rectifying circuit embedded in the host device to be charged. This approach has the disadvantage that the spacing between transmit and receive antennas must be very close (e.g. mms). Though this approach does have the capability to simultaneously charge multiple devices in the same area, this area is typically small, hence the user must locate the devices to a specific area.

Two desirable features of wireless power transfer systems are transferring energy at high power levels and supporting multiple receivers with a single wireless power transmitter. However, a tradeoff exists between these features. A need exists for methods, systems, and devices for enhanced wireless power transfer. More specifically, a need exists for methods, systems, and devices for impedance neutral wireless power receivers.

### BRIEF DESCRIPTION OF THE DRAWINGS

FIG. 1 shows a simplified block diagram of a wireless power transfer system.

FIG. 2 shows a simplified schematic diagram of a wireless power transfer system.

FIG. 3 illustrates a schematic diagram of a loop antenna for use in exemplary embodiments of the present invention.

FIG. 4 is a simplified block diagram of a transmitter, in accordance with an exemplary embodiment of the present invention.

FIG. 5 is a simplified block diagram of a receiver, in accordance with an exemplary embodiment of the present invention.

FIG. 6A illustrates a series resonant structure.

FIG. 6B illustrates a response of the series resonant structure of FIG. 6A.

FIG. 7A illustrates a parallel resonant structure.

FIG. 7B illustrates a response of the parallel resonant structure of FIG. 7A.

FIG. 8 is a model of a network including two loaded receivers.

FIG. 9 is a plot illustrating the effect of metal on a transmitter coil.

FIG. 10 is a plot illustrating the effect of ferrite on a transmitter coil.

FIGS. 11A-11C illustrate a receiver module including one or more materials, according to an exemplary embodiment of the present invention.

FIG. 12 is a circuit diagram of receiver circuitry, in accordance with an exemplary embodiment of the present invention.

FIG. 13 is a more detailed circuit diagram of receiver circuitry, according to an exemplary embodiment of the present invention.

FIG. 14 is another circuit diagram of receiver circuitry, according to an exemplary embodiment of the present invention.

FIG. 15 is yet another circuit diagram of receiver circuitry, in accordance with an exemplary embodiment of the present invention.

FIG. 16 is a flowchart illustrating a method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The term “wireless power” is used herein to mean any form of energy associated with electric fields, magnetic fields, electromagnetic fields, or otherwise that is transmitted between a transmitter to a receiver without the use of physical electrical conductors. Hereafter, all three of this will be referred to generically as radiated fields, with the understanding that pure magnetic or pure electric fields do not radiate power. These must be coupled to a “receiving antenna” to achieve power transfer.

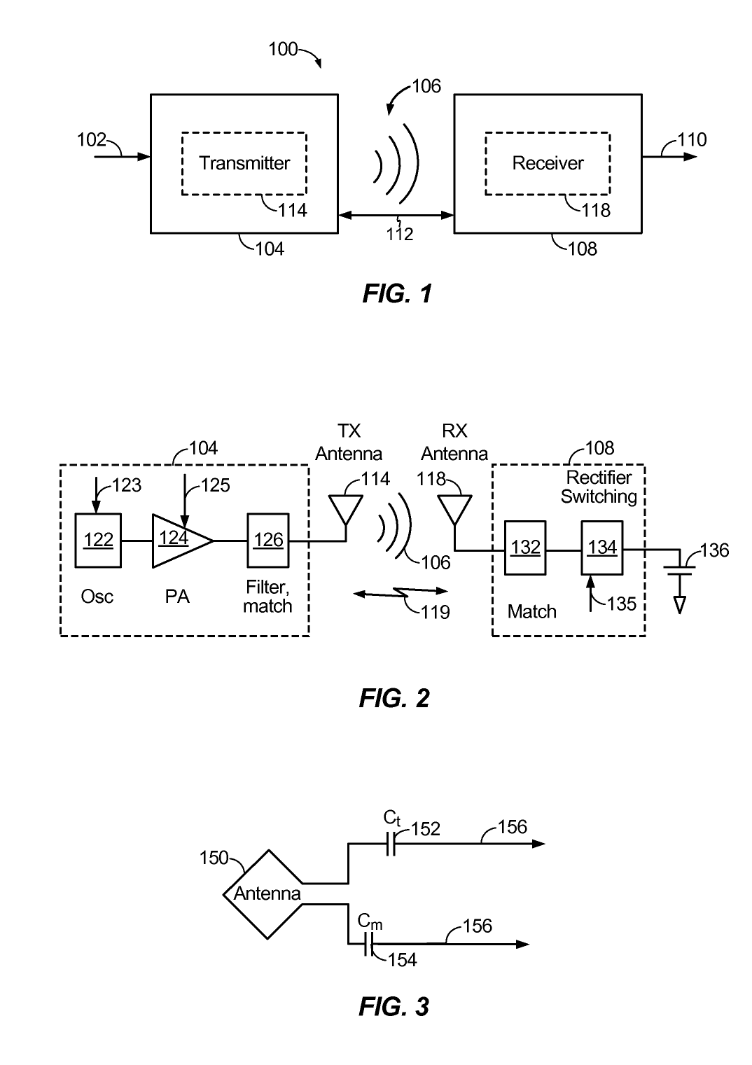

FIG. 1 illustrates a wireless transmission or charging system 100, in accordance with various exemplary embodiments of the present invention. Input power 102 is provided to a transmitter 104 for generating a field 106 for providing energy transfer. A receiver 108 couples to the field 106 and generates an output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the field 106.

Transmitter 104 further includes a transmit antenna 114 for providing a means for energy transmission and receiver 108 further includes a receive antenna 118 for providing a means for energy reception. The transmit and receive antennas are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

FIG. 2 shows a simplified schematic diagram of a wireless power transfer system. The transmitter 104 includes an oscillator 122, a power amplifier 124 and a filter and matching circuit 126. The oscillator is configured to generate at a desired frequency, such as 468.75 KHz, 6.78 MHz or 13.56, which may be adjusted in response to adjustment signal 123. The oscillator signal may be amplified by the power amplifier 124 with an amplification amount responsive to control signal 125. The filter and matching circuit 126 may be included to filter out harmonics or other unwanted frequencies and match the impedance of the transmitter 104 to the transmit antenna 114.

The receiver 108 may include a matching circuit 132 and a rectifier and switching circuit 134 to generate a DC power output to charge a battery 136 as shown in FIG. 2 or power a device coupled to the receiver (not shown). The matching circuit 132 may be included to match the impedance of the receiver 108 to the receive antenna 118. The receiver 108 and transmitter 104 may communicate on a separate communication channel 119 (e.g., Bluetooth, zigbee, cellular, etc).

As illustrated in FIG. 3, antennas used in exemplary embodiments may be configured as a “loop” antenna 150, which may also be referred to herein as a “magnetic” antenna. Loop antennas may be configured to include an air core or a physical core such as a ferrite core. Air core loop antennas may be more tolerable to extraneous physical devices placed in the vicinity of the core. Furthermore, an air core loop antenna allows the placement of other components within the core area. In addition, an air core loop may more readily enable placement of the receive antenna 118 (FIG. 2) within a plane of the transmit antenna 114 (FIG. 2) where the coupled-mode region of the transmit antenna 114 (FIG. 2) may be more powerful.

As stated, efficient transfer of energy between the transmitter 104 and receiver 108 occurs during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the near-field of the transmitting antenna to the receiving antenna residing in the neighborhood where this near-field is established rather than propagating the energy from the transmitting antenna into free space.

The resonant frequency of the loop or magnetic antennas is based on the inductance and capacitance. Inductance in a loop antenna is generally simply the inductance created by the loop, whereas, capacitance is generally added to the loop antenna's inductance to create a resonant structure at a desired resonant frequency. As a non-limiting example, capacitor 152 and capacitor 154 may be added to the antenna to create a resonant circuit that generates resonant signal 156. Accordingly, in one particular example, for larger diameter loop antennas, the size of capacitance needed to induce resonance decreases as the diameter or inductance of the loop increases. Furthermore, as the diameter of the loop or magnetic antenna increases, the efficient energy transfer area of the near-field increases. Of course, other resonant circuits are possible. As another non-limiting example, a capacitor may be placed in parallel between the two terminals of the loop antenna. In addition, those of ordinary skill in the art will recognize that for transmit antennas the resonant signal 156 may be an input to the loop antenna 150.

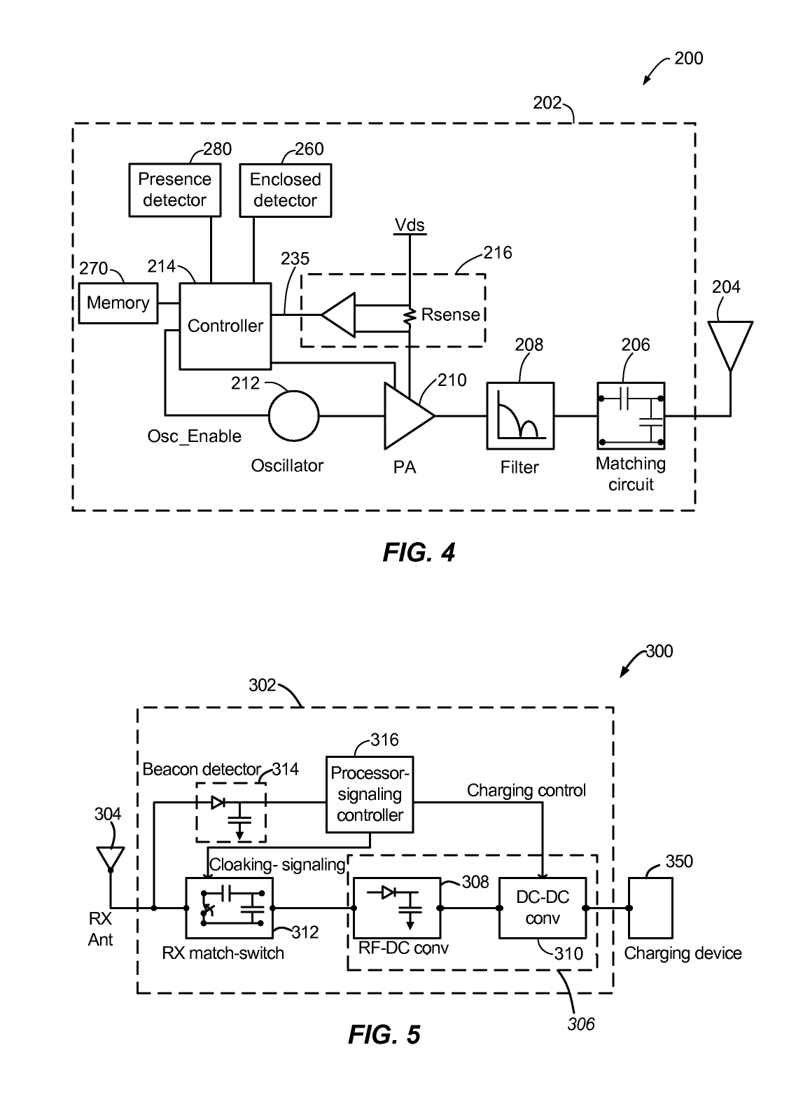

FIG. 4 is a simplified block diagram of a transmitter 200, in accordance with an exemplary embodiment of the present invention. The transmitter 200 includes transmit circuitry 202 and a transmit antenna 204. Generally, transmit circuitry 202 provides RF power to the transmit antenna 204 by providing an oscillating signal resulting in generation of near-field energy about the transmit antenna 204. It is noted that transmitter 200 may operate at any suitable frequency. By way of example, transmitter 200 may operate at the 13.56 MHz ISM band.

Exemplary transmit circuitry 202 includes a fixed impedance matching circuit 206 for matching the impedance of the transmit circuitry 202 (e.g., 50 ohms) to the transmit antenna 204 and a low pass filter (LPF) 208 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that can be varied based on measurable transmit metrics, such as output power to the antenna or DC current drawn by the power amplifier. Transmit circuitry 202 further includes a power amplifier 210 configured to drive an RF signal as determined by an oscillator 212. The transmit circuitry may be comprised of discrete devices or circuits, or alternately, may be comprised of an integrated assembly. An exemplary RF power output from transmit antenna 204 may be on the order of 2.5 Watts.

Transmit circuitry 202 may further include a controller 214 for enabling the oscillator 212 during transmit phases (or duty cycles) for specific receivers, for adjusting the frequency or phase of the oscillator, and for adjusting the output power level for implementing a communication protocol for interacting with neighboring devices through their attached receivers. As is well known in the art, adjustment of oscillator phase and related circuitry in the transmission path allows for reduction of out of band emissions, especially when transitioning from one frequency to another.

The transmit circuitry 202 may further include a load sensing circuit 216 for detecting the presence or absence of active receivers in the vicinity of the near-field generated by transmit antenna 204. By way of example, a load sensing circuit 216 monitors the current flowing to the power amplifier 210, which is affected by the presence or absence of active receivers in the vicinity of the near-field generated by transmit antenna 204. Detection of changes to the loading on the power amplifier 210 are monitored by controller 214 for use in determining whether to enable the oscillator 212 for transmitting energy and to communicate with an active receiver.

Transmit antenna 204 may be implemented with a Litz wire or as an antenna strip with the thickness, width and metal type selected to keep resistive losses low. In a conventional implementation, the transmit antenna 204 can generally be configured for association with a larger structure such as a table, mat, lamp or other less portable configuration. Accordingly, the transmit antenna 204 generally will not need “turns” in order to be of a practical dimension. An exemplary implementation of a transmit antenna 204 may be “electrically small” (i.e., fraction of the wavelength) and tuned to resonate at lower usable frequencies by using capacitors to define the resonant frequency.

The transmitter 200 may gather and track information about the whereabouts and status of receiver devices that may be associated with the transmitter 200. Thus, the transmitter circuitry 202 may include a presence detector 280, an enclosed detector 290, or a combination thereof, connected to the controller 214 (also referred to as a processor herein). The controller 214 may adjust an amount of power delivered by the amplifier 210 in response to presence signals from the presence detector 280 and the enclosed detector 290. The transmitter may receive power through a number of power sources, such as, for example, an AC-DC converter (not shown) to convert conventional AC power present in a building, a DC-DC converter (not shown) to convert a conventional DC power source to a voltage suitable for the transmitter 200, or directly from a conventional DC power source (not shown).

As a non-limiting example, the presence detector 280 may be a motion detector utilized to sense the initial presence of a device to be charged that is inserted into the coverage area of the transmitter. After detection, the transmitter may be turned on and the RF power received by the device may be used to toggle a switch on the Rx device in a pre-determined manner, which in turn results in changes to the driving point impedance of the transmitter.

As another non-limiting example, the presence detector 280 may be a detector capable of detecting a human, for example, by infrared detection, motion detection, or other suitable means. In some exemplary embodiments, there may be regulations limiting the amount of power that a transmit antenna may transmit at a specific frequency. In some cases, these regulations are meant to protect humans from electromagnetic radiation. However, there may be environments where transmit antennas are placed in areas not occupied by humans, or occupied infrequently by humans, such as, for example, garages, factory floors, shops, and the like. If these environments are free from humans, it may be permissible to increase the power output of the transmit antennas above the normal power restrictions regulations. In other words, the controller 214 may adjust the power output of the transmit antenna 204 to a regulatory level or lower in response to human presence and adjust the power output of the transmit antenna 204 to a level above the regulatory level when a human is outside a regulatory distance from the electromagnetic field of the transmit antenna 204.

As a non-limiting example, the enclosed detector 290 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 200 does not remain on indefinitely may be used. In this case, the transmitter 200 may be programmed to shut off after a user-determined amount of time. This feature prevents the transmitter 200, notably the power amplifier 210, from running long after the wireless devices in its perimeter are fully charged. This event may be due to the failure of the circuit to detect the signal sent from either the repeater or the receive coil that a device is fully charged. To prevent the transmitter 200 from automatically shutting down if another device is placed in its perimeter, the transmitter 200 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a simplified block diagram of a receiver 300, in accordance with an exemplary embodiment of the present invention. The receiver 300 includes receive circuitry 302 and a receive antenna 304. Receiver 300 further couples to device 350 for providing received power thereto. It should be noted that receiver 300 is illustrated as being external to device 350 but may be integrated into device 350. Generally, energy is propagated wirelessly to receive antenna 304 and then coupled through receive circuitry 302 to device 350.

Receive antenna 304 is tuned to resonate at the same frequency, or within a specified range of frequencies, as transmit antenna 204 (FIG. 4). Receive antenna 304 may be similarly dimensioned with transmit antenna 204 or may be differently sized based upon the dimensions of the associated device 350. By way of example, device 350 may be a portable electronic device having diametric or length dimension smaller that the diameter of length of transmit antenna 204. In such an example, receive antenna 304 may be implemented as a multi-turn antenna in order to reduce the capacitance value of a tuning capacitor (not shown) and increase the receive antenna's impedance. By way of example, receive antenna 304 may be placed around the substantial circumference of device 350 in order to maximize the antenna diameter and reduce the number of loop turns (i.e., windings) of the receive antenna and the inter-winding capacitance.

Receive circuitry 302 provides an impedance match to the receive antenna 304. Receive circuitry 302 includes power conversion circuitry 306 for converting a received RF energy source into charging power for use by device 350. Power conversion circuitry 306 includes an RF-to-DC converter 308 and may also in include a DC-to-DC converter 310. RF-to-DC converter 308 rectifies the RF energy signal received at receive antenna 304 into a non-alternating power while DC-to-DC converter 310 converts the rectified RF energy signal into an energy potential (e.g., voltage) that is compatible with device 350. Various RF-to-DC converters are contemplated, including partial and full rectifiers, regulators, bridges, doublers, as well as linear and switching converters.

Receive circuitry 302 may further include switching circuitry 312 for connecting receive antenna 304 to the power conversion circuitry 306 or alternatively for disconnecting the power conversion circuitry 306. Disconnecting receive antenna 304 from power conversion circuitry 306 not only suspends charging of device 350, but also changes the “load” as “seen” by the transmitter 200 (FIG. 2).

As disclosed above, transmitter 200 includes load sensing circuit 216 which detects fluctuations in the bias current provided to transmitter power amplifier 210. Accordingly, transmitter 200 has a mechanism for determining when receivers are present in the transmitter's near-field.

When multiple receivers 300 are present in a transmitter's near-field, it may be desirable to time-multiplex the loading and unloading of one or more receivers to enable other receivers to more efficiently couple to the transmitter. A receiver may also be cloaked in order to eliminate coupling to other nearby receivers or to reduce loading on nearby transmitters. This “unloading” of a receiver is also known herein as a “cloaking ” Furthermore, this switching between unloading and loading controlled by receiver 300 and detected by transmitter 200 provides a communication mechanism from receiver 300 to transmitter 200 as is explained more fully below. Additionally, a protocol can be associated with the switching which enables the sending of a message from receiver 300 to transmitter 200. By way of example, a switching speed may be on the order of 100 μsec.

In an exemplary embodiment, communication between the transmitter and the receiver refers to a device sensing and charging control mechanism, rather than conventional two-way communication. In other words, the transmitter may use on/off keying of the transmitted signal to adjust whether energy is available in the near-field. The receivers interpret these changes in energy as a message from the transmitter. From the receiver side, the receiver may use tuning and de-tuning of the receive antenna to adjust how much power is being accepted from the near-field. The transmitter can detect this difference in power used from the near-field and interpret these changes as a message from the receiver. It is noted that other forms of modulation of the transmit power and the load behavior may be utilized.

Receive circuitry 302 may further include signaling detector and beacon circuitry 314 used to identify received energy fluctuations, which may correspond to informational signaling from the transmitter to the receiver. Furthermore, signaling and beacon circuitry 314 may also be used to detect the transmission of a reduced RF signal energy (i.e., a beacon signal) and to rectify the reduced RF signal energy into a nominal power for awakening either un-powered or power-depleted circuits within receive circuitry 302 in order to configure receive circuitry 302 for wireless charging.

Receive circuitry 302 further includes processor 316 for coordinating the processes of receiver 300 described herein including the control of switching circuitry 312 described herein. Cloaking of receiver 300 may also occur upon the occurrence of other events including detection of an external wired charging source (e.g., wall/USB power) providing charging power to device 350. Processor 316, in addition to controlling the cloaking of the receiver, may also monitor beacon circuitry 314 to determine a beacon state and extract messages sent from the transmitter. Processor 316 may also adjust DC-to-DC converter 310 for improved performance.

Loosely coupled wireless power systems, as will be understood by a person having ordinary skill in the art, are capable of delivering high power to wireless power receivers in a wide range of positions and orientations. These systems may provide desired levels of power transfer by relying on resonant structures present on a transmit side (i.e., a wireless power transmitter) and a receive side (i.e., wireless power receiver). The ability to transfer high levels of power and the ability to support multiple receivers with varying power requirements from a single transmitter concurrently are desirable features of wireless power systems. Unfortunately, due to the resonant structure of wireless power receivers, a trade-off exists between these two features, thus, limiting the functionality of loosely coupled wireless power system.

This trade-off is correlated to an impedance transformation element of loosely coupled systems, which directs the power delivered to each receiver. In various configurations, as multiple receivers (i.e., loads) are place within a charging region of a transmitter, the variance in impedance from each receiver, correlated to its power needs, may reduce the overall power deliverable by the system. Accordingly, one or more receivers may not receive adequate power. In other configurations, as multiple receivers (i.e., loads) are place within a charging region of a transmitter, the variance in impedance from each receiver, correlated to its power needs, may increase the overall power received by a receiver, which may cause over-charging and possibly damage to the receiver.

As will be appreciated by a person having ordinary skill, a transmitter within a loosely coupled wireless power system may be configured as a series resonant structure and a receiver within the loosely coupled wireless power system may be configured as a parallel resonant structure. Series and parallel resonance presents the impedance response and the resonant frequency of a transmitter and a receiver. The impedance of resonant structures may depend on the location of their resonant frequency relative to the frequency at which power is transmitted.

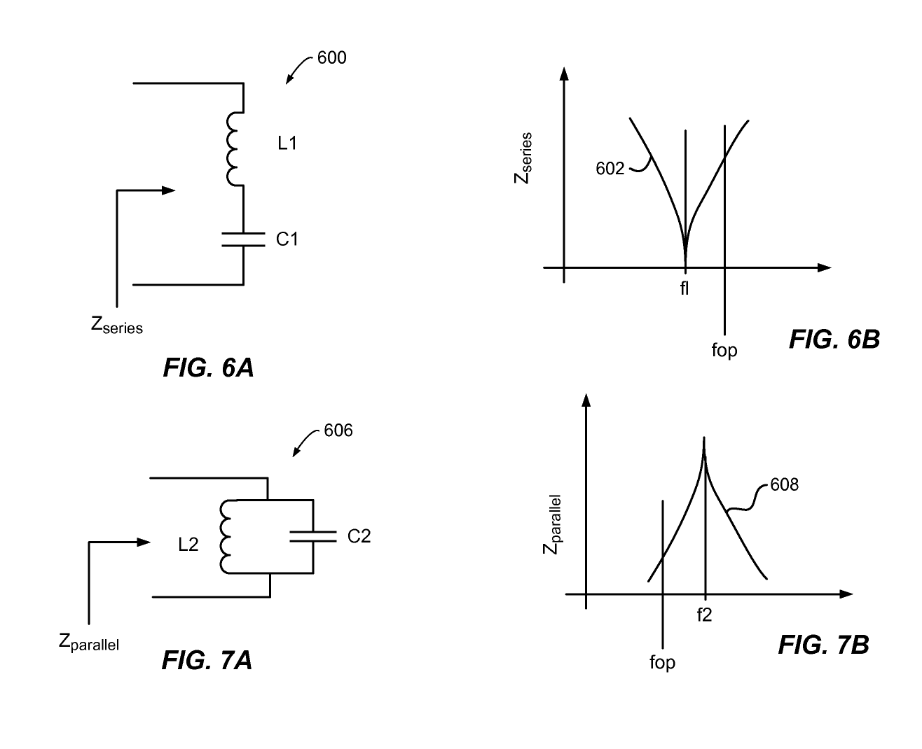

FIGS. 6A illustrates a series resonant structure 600 and FIG. 6B illustrates a frequency response 602 of series resonant structure 600. With reference to FIGS. 6A and 6B, as the frequency of operation fop approaches the resonant frequency f1, which may be defined as f1= 1/2√π\sqrt{L₁C₁}, the impedance Zseries approaches zero. Further, as the frequency of operation fop is moved away from the resonant frequency f1, the impedance Zseries increases. FIGS. 7A illustrates a parallel resonant structure 606 and FIG. 7B illustrates a frequency response 608 of parallel resonant structure 606. With reference to FIGS. 7A and 7B, as the frequency of operation fop approaches the resonant frequency f2, which may be defined as f2=½π\sqrt{L₂C₂}, the impedance Zparallel approaches infinity. Further, as the frequency of operation fop is moved away from the resonant frequency f2, the impedance Zparallel decreases.

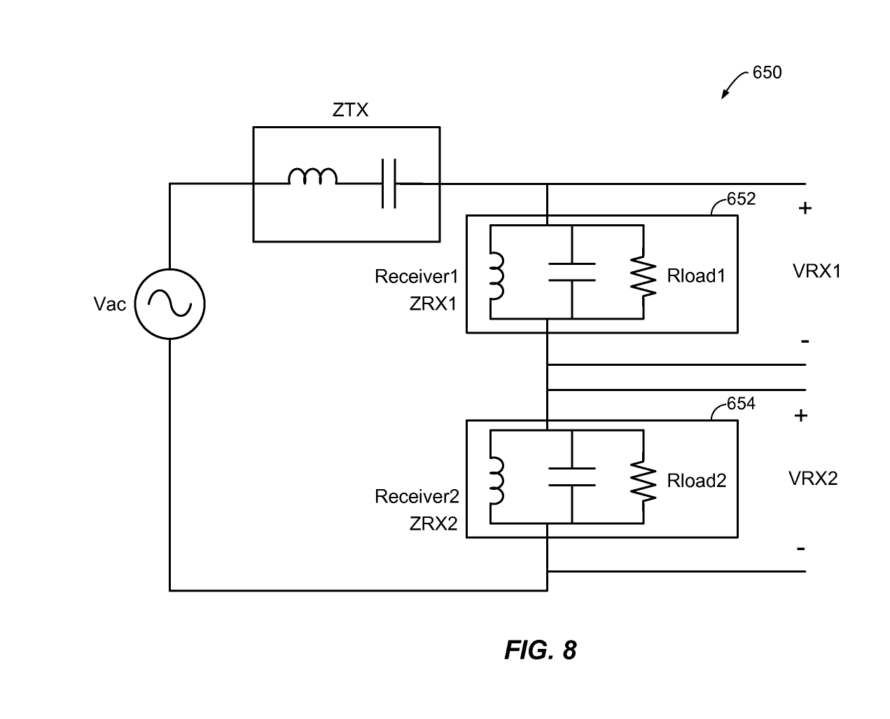

FIG. 8 illustrates a model of a network 650 including two loaded receivers, depicted as 652 and 654, which are driven by a single transmitter. As will be appreciated by a person having ordinary skill, in a conventional system, receiver 652 may have an effect on the rest of network 650 (i.e., receiver 654 as well as the associated transmitter). Similarly, receiver 654 may have an effect on the rest of network 650 (i.e., receiver 652 as well as the associated transmitter). More specifically, for example, if receiver 652 is heavily loaded (i.e., Rload1 is small), receiver 652 will have a negligible effect on the rest of network 650. Further, if receiver 652 is lightly loaded (i.e., Rload1 is large), an impedance Zrx1 of receiver 652 may be large, effectively reducing an amount of power delivered to other receivers (i.e., receiver 654).

Various exemplary embodiments of the present invention, as described herein, relate to systems, devices, and methods for impedance neutral receivers, which may enable multiple receivers to receive wireless power without substantially interfering with one another. Stated another way, various exemplary embodiments relate to systems, devices, and methods for impedance neutral receivers, which are configured to be tuned according to an associated load to enable an impedance as seen by an associated transmitter to remain substantially constant upon positioning the receiver within a charging region of the transmitter. According to one exemplary embodiment, an optimal amount of metal, ferrite, or a combination thereof may be included within a receiver module to tune the receiver to provide an impedance neutral receiver. According to another exemplary embodiment, a tuning frequency of a receiver may be changed in response to a loading condition to provide an impedance neutral receiver.

As will be appreciated by a person having ordinary skill in the art, in conventional systems, a lightly loaded, parallel-tuned receiver may add a significant impedance value to an AC network, thus reducing the power available to other receivers. According to one exemplary embodiment of the present invention, an impedance of an AC network may be modified by compensating for the effects caused by a receiver by reducing the impedance as seen by the transmitter by the same amount. Stated another way, a “makeup” of the receiver may be modified and tuned according to a load of the receiver to enable the receiver to appear to an associated transmitter as impedance neutral. More specifically, the impedance as seen by the transmitter due to a receiver may be modified by placing metal material, ferrous material, or both within a receiver module of the receiver. It is noted that when receivers within a wireless power system appear to a transmitter as impedance neutral, the wireless power system may provide adequate power to each of the receivers.

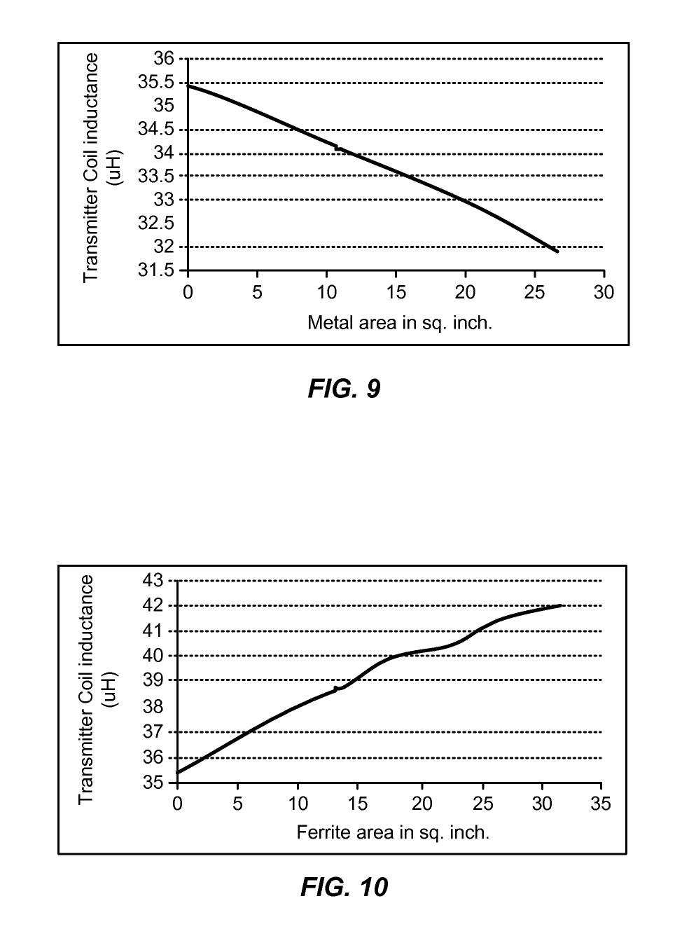

With reference to FIGS. 9 and 10, it is noted that metal and ferrite may each affect an inductance of a wireless power transmitter. More specifically, as illustrated in FIG. 9, metal, which may already be present within an electronic device, decreases the inductance of a transmitter coil. Due to the series configuration of the transmitter (i.e., f1=½π\sqrt{L₁C₁}), as noted above, a decrease in inductance L₁ increases the resonant frequency f1. Moving the resonant frequency f₁ closer to the frequency of operation (fₒₚ) reduces the impedance of the transmitter. The inverse is true for ferrous material. As illustrated in FIG. 10, ferrous material may increase the inductance L1 of the transmitter coil.

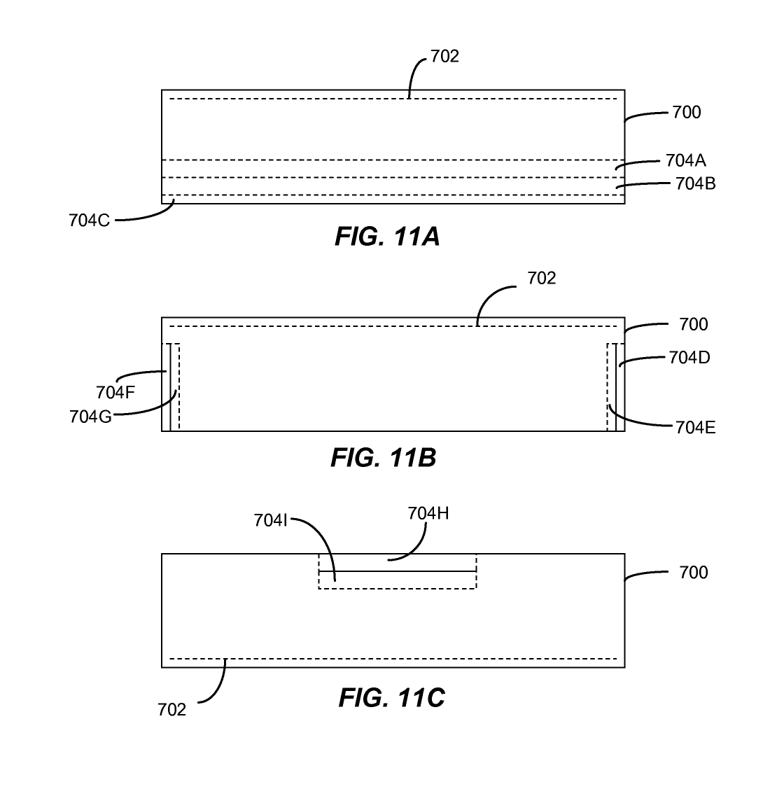

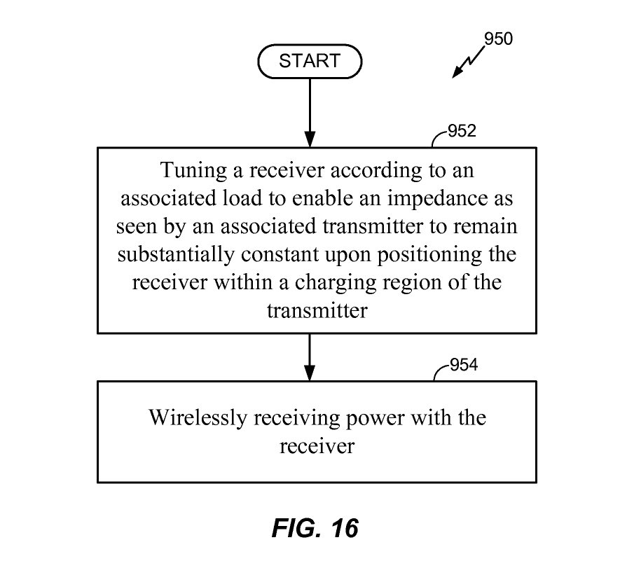

Various exemplary embodiments of the present invention will now be described with reference to FIGS. 11A-16. In accordance with one exemplary embodiment, with reference to FIGS. 11A, 11B, and 11C, a receiver module 700 of a receiver (e.g., receiver 300 of FIG. 5) may include an optimal quantity of metal, ferrite, or a combination thereof to tune the receiver. The receiver may be tuned according to an associated load to enable an impedance as seen by an associated transmitter to remain substantially constant upon positioning the receiver within a charging region of the transmitter. Stated another way, the receiver may be tuned, via an optimal amount of metal, ferrite, or both, to enable the receiver to appear to an associated transmitter as impedance neutral.

As illustrated in FIGS. 11A-11C, receiver module 700 includes a receiver coil 702 (i.e., a receive antenna). Further, receiver module 700 may include one or more materials (i.e., materials 704A-704I). By way of example only, material 704 may comprise sheets of material, such as ferrite or metal. As one example, materials 704A and 704B may comprise a metal sheet, and material 706C may comprise a ferrite sheet, or vice versa. As another example, each of material 704A, 704B, and 704C may comprise either metal of ferrite. FIGS. 11A, 11B, and 11C illustrate example orientations and positions of materials within receiver module 700, however, it is noted that materials may be positioned within receiver module 700 in any suitable manner. For example, materials 704 may be oriented in a substantially similar direction as coil 702, as illustrated in FIGS. 11A and 11C. As another example, materials 704 may be oriented in a substantially perpendicular direction to coil 702, as illustrated in FIG. 11B.

According to one exemplary embodiment, metal, which is already present within an electronic device, may be utilized for tuning the receiver to appear to an associated transmitter as impedance neutral. Further, in accordance with an exemplary embodiment, a metal material (e.g., a metal sheet), in addition to metal already existing within an electronic device, may be positioned over a ferrous material (e.g., a ferrite sheet) so that the electronic device includes metal for compensation in addition to metal that already existed in the electronic device. This may enable for reliable tuning of the receiver even when the metal, which already existed in the electronic device, is unknown or imperfectly calculated. For example, with reference to FIG. 11C, receiver module 700, which may already include metal, may comprise a material 704I, which in this example comprises ferrite, and a material 704H, which in this example comprises metal.

It is noted that an optimal amount of material, or materials (i.e., ferrite, metal, or both), to be included within a receiver module may be determined through experimentation. For example, an optimal amount of material, or materials, to enable the receiver to appear to an associated transmitter as impedance neutral, may be determined through experimentation performed on a known device having a known load.

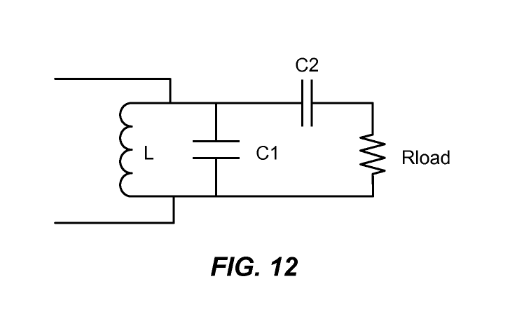

According to another exemplary embodiment of the present invention, a capacitive loading technique may be utilized to enable a receiver to appear to an associated transmitter as impedance neutral. More specifically, a tuning frequency of a receiver circuit of a receiver (e.g., receiver 300 of FIG. 5) may be changed in response to a loading condition. When the receiver is heavily loaded, the receiver may be tuned closer to resonance. When the receiver is lightly loaded, the receiver may be tuned further away from resonance. According to this exemplary embodiment, with reference to FIG. 12, a tuning capacitor in the receiver is split in two portions (i.e., capacitor C1 and capacitor C2), with one portion (i.e., capacitor C1) in parallel with a receiver coil L, and the other portion (i.e., capacitor C2) in series with a load Rload.

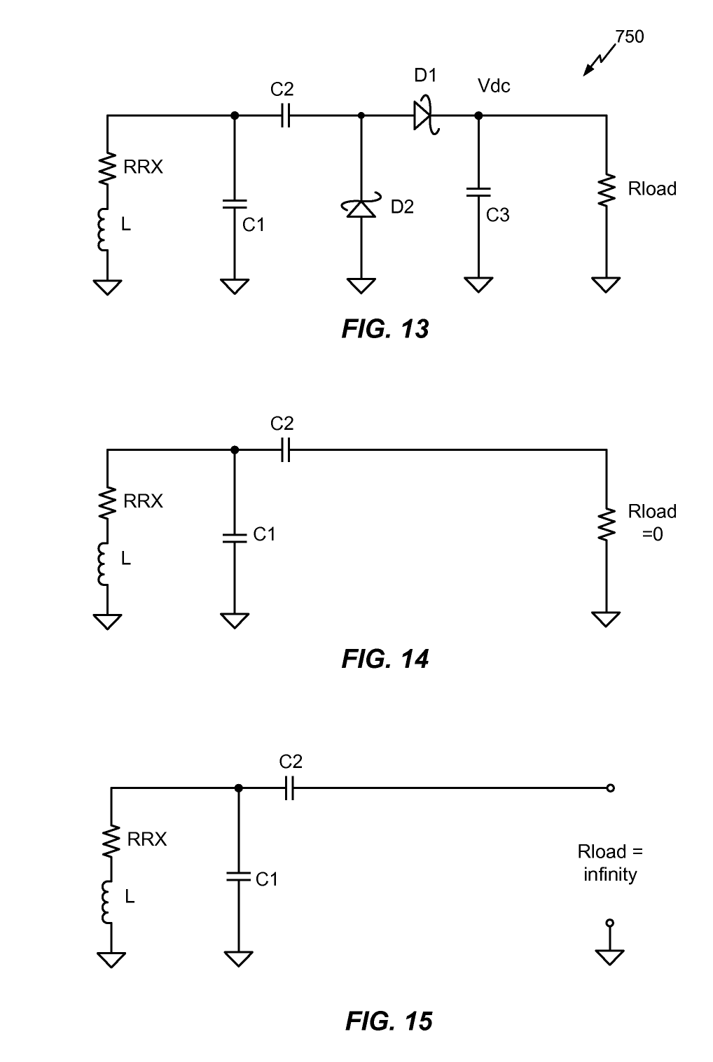

As illustrated in FIG. 12, load Rload is a voltage rectifier, which to enable a capacitive loading design, may include a voltage doubler based divider. A more complete circuit 750 is illustrated in FIG. 13. Circuit 750 includes diodes D1 and D2 that are in a voltage doubler configuration in which diode D1 rectifies an AC signal at an output of capacitor C2. The AC signal also reaches diode D2, and, due to the DC block provided by capacitor C2, the output of diode D2 is combined with a source voltage. Accordingly, an output of the doubler (i.e., voltage Vdc) is greater than the peak voltage of the source. The significance of adding capacitor C2 may be further understood by its effect of determining a frequency of operation of the receiver at different loads.

At a heavy load (i.e., Rload=0), capacitor C1 and capacitor C2 are in parallel. Neglecting the effect of filtering capacitor C3, an equivalent circuit is illustrated in FIG. 14. As will be appreciated by a person having ordinary skill in the art, the capacitance of the receiver increases, thus moving the receiver closer to resonance. In this case, the frequency may be approximated as f=½π{square root over (L₁(C₁+C₂)}. At heavy loads, this configuration presents increased capacitive receiver impedance, thus enhancing energy transfer.

At light loads (i.e., Rload=∞), neglecting the effect of filtering capacitor C3, an equivalent circuit is illustrated in FIG. 15. Accordingly, the effective capacitance is equal to capacitor C1. In this case, the frequency may be approximated as f=½π\sqrt{LC₁}. Thus, under light loading conditions, the receiver automatically tunes itself away from the frequency of operation. This decrease in impedance may cause the receiver to be nearly transparent to other receivers.

FIG. 13 is a flowchart illustrating another method 950, in accordance with one or more exemplary embodiments. Method 950 may include tuning a receiver according to an associated load to enable an impedance as seen by an associated transmitter to remain substantially constant upon positioning the receiver within a charging region of the transmitter (depicted by numeral 952). Method 950 may further include wirelessly receiving power with the receiver (depicted by numeral 954).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A receiver, comprising:
receive circuitry configured to couple to a load;
wherein the receiver is configured to be tuned according to the load to enable an impedance as seen by an associated transmitter to remain substantially constant upon positioning the receiver within a charging region of the transmitter.

2. The receiver of claim 1, the receive circuitry including at least one capacitor in series with the load for tuning the receiver.

3. The receiver of claim 2, the receive circuitry further comprising at least one capacitor in parallel with a receiver coil.

4. The receiver of claim 1, further comprising an amount of at least one of metal material and ferrous material to tune the receiver according to the load to enable the impedance as seen by the associated transmitter to remain substantially constant upon positioning the receiver within the charging region of the transmitter.

5. The receiver of claim 4, the amount of at least one of metal material and ferrous material for compensating for effects on the transmitter caused by other portions of the receiver.

6. The receiver of claim 4, the amount of at least one of metal material and ferrous material comprising at least one metal sheet over at least one ferrite sheet.

7. The receiver of claim 4, the metal material comprising one or more metal sheets.

8. The receiver of claim 4, the ferrous material comprising one or more ferrite sheets.

9. The receiver of claim 1, further configured to be tuned according to the load to enable an inductance of the associated transmitter to remain substantially constant upon positioning the receiver within a charging region of the transmitter.

10. The receiver of claim 9, further comprising a receiver module including the receive circuitry, the receiver module including an amount of at least one of metal material and ferrite material proximate the receive circuitry to tune the receiver according to the load to enable the impedance as seen by the associated transmitter to remain substantially constant upon positioning the receiver within the charging region of the transmitter.

11. A method, comprising:
tuning a receiver according to an associated load to enable an impedance as seen by an associated transmitter to remain substantially constant upon positioning the receiver within a charging region of the transmitter; and
wirelessly receiving power with the receiver.

12. The method of claim 11, the tuning comprising positioning an amount of at least one of metal material and ferrous material within the receiver.

13. The method of claim 11, the positioning comprising positioning at least one of one or more metal sheets and one or more ferrite sheets within the receiver.

14. The method of claim 11, the positioning comprising positioning at least one metal sheet over at least one ferrite sheet within the receiver.

15. The method of claim 11, the tuning comprising reducing an inductance of the receiver with ferrous material.

16. The method of claim 11, the tuning comprising increasing an inductance of the receiver with metal material.

17. The method of claim 11, the tuning comprising modifying a tuning frequency of the receiver in response to the associated load.

18. The method of claim 17, the modifying comprising tuning the tuning frequency either toward resonance or away from resonance in response to the associated load.

19. The method of claim 11, the tuning comprising tuning the receiver according to the associated load to enable an inductance of an associated transmitter to remain substantially constant upon positioning the receiver within a charging region of the transmitter.

20. The method of claim 11, the tuning comprising tuning the receiver with at least one capacitor in series with the associated load.

21. The method of claim 20, the tuning further comprising tuning the receiver with at least one capacitor in parallel with a receiver coil.

22. A device, comprising:
means for tuning a receiver according to an associated load to enable an impedance as seen by an associated transmitter to remain substantially constant upon positioning the receiver within a charging region of the transmitter; and
means for wirelessly receiving power with the receiver.

23. The device of claim 22, the means for tuning comprising means for tuning the receiver with an amount of at least one of metal material and ferrous material within the receiver.

24. The device of claim 22, the means for tuning comprising means for tuning the receiver with at least one capacitor in series with the associated load.

25. The device of claim 22, the means for tuning comprising means for modifying a tuning frequency of the receiver in response to the associated load.
